(19) United States
(12) Patent Application Publication
(10) Pub. No.: US 2017/0298778 A1
(43) Pub. Date: Oct. 19, 2017

(54) ASSEMBLING AID FOR ASSEMBLING/DE-ASSEMBLING A TURBINE ASSEMBLY

(71) Applicant: Siemens Aktiengesellschaft, Munich (DE)

(72) Inventor: Philip Twell, Welton (GB)

(73) Assignee: Siemens Aktiengesellschaft, Munich (DE)

(21) Appl. No.: 15/289,329

(22) Filed: Oct. 10, 2016

(30) Foreign Application Priority Data
Oct. 13, 2015 (EP) 15189515.8

(51) Int. Cl. F01D 25/28; B25B 11/02

(52) U.S. Cl. CPC F01D 25/285; B25B 11/02; F05D 2230/60

(57) ABSTRACT

An assembling aid for assembling or de-assembling a turbine assembly having at least two aerofoil assemblies connected to each other by at least two interlocking platforms, wherein the at least two aerofoil assemblies are brought from a free-state untwisted position to an assembled twisted position during assembling, including at least one slot embodied to receive at least one part of an aerofoil assembly, wherein the at least one slot has an entry aperture and an exit aperture. A width of the entry aperture of the at least one slot is wider than a width of the exit aperture of the at least one slot.

### CROSS REFERENCE TO RELATED APPLICATIONS

This application claims the benefit of European Application No. EP15189515 filed 13 Oct. 2015, incorporated by reference herein in its entirety.

### FIELD OF THE INVENTION

The present invention relates to an assembling aid for assembling or de-assembling a turbine assembly. The present invention further relates to a method for assembling a turbine assembly.

BACKGROUND TO THE INVENTION

Modern turbine engines often operate at extremely high temperatures. Not only can the effect of temperature on the turbine blades and/or stator vanes (aerofoils) be detrimental to the efficient operation of the turbine engine and can, in extreme circumstances, lead to distortion and possible failure of the blade or vane, but the high temperatures may also cause pressure fluctuations and vibrations in the turbine. Even during occurrence of such working conditions there is the need that turbine parts, like the turbine blades, maintain their integrity and work reliably. Where turbine blades are vulnerable to vibration problems the outer shrouds may be of an interlocked design. In this case it may not be possible to individually install blades into the turbine disc; instead they must be fitted simultaneously.

Previously, this problem has been solved by careful manual insertion of the aerofoils into the production disc and gently tapping with a mallet in a continuous spiral pattern to insert axially. This method uses the production disc to exert a torsional force onto the aerofoils. There is significant risk of damage to either aerofoil or production disc. Also this method is time consuming and limited to small aerofoils which may require only minimal torsional loading which can be applied manually.

Furthermore, it is required to ensure that interlock faces between adjacent aerofoils are in contact during worst tolerance conditions and extremes of turbine engine operation when there may otherwise be a gap present. This is necessary to ensure that the vibrational behaviour of the aerofoils is controlled and there is a damping mechanism present. In order to achieve this contact high temperature turbine blades may include shrouds that are oriented about the blade radial axis with the blade in its free state.

However, depending upon the aerofoil shape, the angle of shroud orientation in the free state may be relatively large. This means that a large twisting force must be applied to the aerofoils, typically increasing the angle of shroud orientation, in the cold build condition when assembled into a production disc connecting several aerofoils. The application of a twisting force during assembly increases the difficulty of having to simultaneously assemble blades into a production disc because the shrouds are interlocked.

It is a first objective of the invention to provide an assembling aid to assemble or de-assemble a turbine assembly easy and quick.

It is a second objective of the present invention to provide a method for assembling or de-assembling a turbine assembly with which the above-mentioned shortcomings can be mitigated, and especially a more aerodynamic efficient aerofoil and gas turbine component is facilitated. A third objective of the invention is to provide an advantageous turbine assembly assembled by the inventive method.

### SUMMARY OF THE INVENTION

Accordingly, the present invention provides an assembling aid for assembling or de-assembling a turbine assembly comprising at least two aerofoil assemblies connected to each other by at least two interlocking platforms, wherein the at least two aerofoil assemblies (12, 14) are brought from a free-state untwisted position to an assembled twisted position during assembling, comprising at least one slot embodied in such a way to receive at least one part of an aerofoil assembly, wherein the at least one slot has an entry aperture and an exit aperture.

It is proposed that a width of the entry aperture of the at least one slot is wider than a width of the exit aperture of the at least one slot.

Due to the inventive matter aerofoil assemblies that requiring a high torsional pre-load can be fitted easily in the turbine assembly or its production disc, respectively. Further, the aerofoil assemblies can be effectively positioned from their free-state untwisted position to the assembled twisted position. Moreover, assembling time is minimised. Furthermore, an equal twisting moment is applied to both aerofoil assemblies providing a homogeneous arrangement or twisting angle of the aerofoil assemblies.

Even if a term like assembling aid, aerofoil, platform, slot, aperture, surface, taper, facet, curve, root portion, support or production disc is used in the singular or in a specific numeral form in the claims and the specification the scope of the patent (application) should not be restricted to the singular or the specific numeral form. It should also lie in the scope of the invention to have more than one or a plurality of the above mentioned structure(s).

In this context an assembling aid is intended to mean a structure, tool or functionally interacting group of pieces/tools that assist an assembling or de-assembling of a turbine assembly. The assembling aid or parts thereof may be a part of the resulting turbine assembly or its purpose may be primarily or only focused to the assembly/de-assembly process and the assembling aid or parts thereof may be removed after these actions. The assembling aid may be attached to a fixture of the assembling aid for better handling.

A turbine assembly is intended to mean an assembly provided for a turbine engine, like a gas turbine, wherein the assembly possesses at least an aerofoil assembly. Advantageously, the turbine assembly has a turbine wheel or a turbine cascade with circumferential arranged aerofoil assemblies. An aerofoil assembly is intended to mean an assembly for a turbine assembly that comprises at least an aerofoil, an outer and an inner platform arranged at opponent ends of the aerofoil(s). The aerofoil assemblies of a turbine wheel are connected with one another by a production disc. Therefore, the aerofoil assembly comprises a root portion that is attached via the radially inner platform to the aerofoil. The root portion is inserted into a corresponding slot of the production disc during an assembling of the turbine assembly. Furthermore, the root portion may have a Christmas tree shape.

In this context an interlocking platform is intended to mean a platform of an aerofoil assembly that is connected to another part of the turbine assembly, advantageously, an adjacently arranged aerofoil assembly or specifically, a platform of the latter. The connection may be facilitated via a form fit and/or a force fit. During an operation of the turbine engine the fit between adjacent platforms/shrouds is advantageously a force fit. This is enabled by rotation of the shroud caused by twisting of the aerofoil during assembly and modified by un-twisting of the aerofoil under centrifugal force/load. In other words, when the gas turbine is running the contact between adjacent platforms/shrouds is reduced due to the impact of the centrifugal force. Thus, by assembling the aerofoils in a twisted configuration it is ensured to have some level of contact remaining when in use. Advantageously, a force fit will exist in a non-operational state due to the twisting force required to assemble the aerofoils being reacted at the faces of the interlocking shroud.

It is further provided, that the interlocking platform is an outer platform of the aerofoil assembly and specifically a shroud. Since the outer platform or shroud, respectively, is the part of the aerofoil assembly that is positioned the farthest away from the portion of the aerofoil assembly that is mounted to the production disc—the root portion—(see below) it is the part of the aerofoil assembly, which has the highest risk of mounting tolerances. Hence, by applying the assembling method to the outer platform a reliable turbine assembly can be obtained (see below).

If the aerofoil assembly is a turbine blade the method can beneficially by applied to a part of the turbine engine that is submitted to high stresses and needs a good integrity especially during rotation.

A “free state untwisted position” of the aerofoil assemblies is intended to mean an arrangement of the at least two aerofoil assemblies in a unloaded/unstressed position, a free condition, an untwisted position relative to its fully assembled state and/or a position of two aerofoil assemblies in respect towards each other with at least or solely a form fit. In other words, it means a free state or a state of rest, in which the aerofoil is not exposed to any external forces. Hence, in this position a form fit between the aerofoil assemblies may be established. Moreover, an “assembled twisted position” is intended to mean an arrangement of the at least two aerofoil assemblies in respect towards each other that provides a loaded connection (with a force fit and a tight form fit) between the aerofoil assemblies i.e. an external force is applied to the aerofoil to elastically change the shape of the aerofoil and/or that is adjusted prior to the final assembly step of the turbine assembly. In the latter case this position may also be named pre-assembling position.

In use as the rotor is rotating, the aerofoil will strive to move towards an “untwisted position” due to the exposure of the centrifugal forces acting upon it. The effect of the untwisting motion causes the effective span of the interlocking platform/shroud to increase which causes the contact forces between the shrouds to increase and thus maintain a damping effect.

It is provided that the twisting moment to achieve the twisted position is sufficiently applied to allow fitting of the aerofoils.

Further, the twisting moment, a twisting force or torsion can be applied by any method or means feasible for a person skilled in the art. Advantageously, it is applied at least partly by the assembling aid resulting in a comfortable and easy to actuate procedure.

Additionally, and alternatively, it may be also possible that the twisting moment results in torsion of the aerofoil assembly in itself or of parts thereof.

Due to the wider entry aperture there will be a distance/spacing between the inserted part of the aerofoil assembly, namely the root portion, and the restricting walls of the at least one slot positioned at the entry aperture. Since the exit aperture is smaller a distance between the slot wall(s) at the exit aperture and the inserted part of the aerofoil assembly is less than the distance at the entry aperture. Hence, a distance between the inserted part of the aerofoil assembly and the slot wall(s) reduces along a depth of the slot.

The at least one slot has a depth extending from the entry aperture to the exit aperture. Advantageously, a width of the slot will reduce along the depth or specifically from the entry to the exit aperture. This may be achieved in any fashion feasible for a person skilled in the art, for example step-wise, gradually or linearly. The reduction in width may also take place only along a part of the depth. In a further advantageous embodiment it is provided that the width of the at least one slot reduces in a continuous, advantageously linear, fashion. Hence, the engagement of the part of the aerofoil assembly inserted into the slot and the slot wall(s) can be performed smoothly and increased slowly.

Furthermore, the at least one slot has at least one side surface extending along the depth of the at least one slot. The side surface is intended to mean the surface of the slot of which at least one part will engage or contact the inserted part during the insertion process. Advantageously, the at least one slot has at least two side surfaces which extend both along the depth of the slot (from the entry to the exit aperture) and which are arranged at opposed sides of the slot. These two sides may be arranged in the same orientation or may be arranged differently in respect to a centreline of the slot. For example one surface in flared in respect to the centre line and the other one is in parallel. Or one surface is flared with a first angle and the other surface with another angle.

Advantageously and a stated above, the least one slot has a centre line along the depth of the at least one slot. In this context a centre line is intended to mean a line extending along an insertion direction of the part of the aerofoil assembly. Advantageously, the centre line provides at least one kind of symmetry of the slot or parts thereof. Beneficially, the symmetry is a mirror symmetry.

In an advantageous realisation of the invention it is provided that the at least one side surface is angled with a taper along the depth of the at least one slot and in respect to the centre line of the at least one slot. In other words, the side surface is flared. Thus the linear engagement can be realised easily and the selected orientation of the side surface can be manufactured easily.

According to a further embodiment of the invention an angle included between the at least one side surface of the at least one slot and the centre line of the at least one slot has a value between 0° and ±15°, advantageously between 0° and ±10° and most advantageously between 0° and ±6°. These values have shown to provide a sufficient balance between a needed space at the entry aperture for the insertion process and a smooth linear engagement or increased contact force between the side surface and the inserted part of the aerofoil assemblies. The selected angle is for example dependent the needed pre-twist of the aerofoil assemblies and/or on the depth of the slot as well as the length of the inserted part. Since an angel of 0° would have no deviation to the orientation of the centre line, the strict angel of 0° should not be integrated in the value range.

Alternatively, the at least one side surface comprises a plurality of facets to simulate a curve along the depth of the at least one slot and in respect to the centre line of the at least one slot. Such a multi-faceted profile may enable less force to be applied as the rate of change twist, as the part of the aerofoil assembly is inserted, is reduced. In this context a plurality of facet is intended to mean a sequence of several straight forms. This sequence approximates a curve. However, the effective slot width needs to taper. As above, the curvature of the curve depends on the characteristics of the slot, the inserted part and the achieved twisting result.

The slot may be machined/created by any method feasible for a person skilled in the art. Possibilities would be, for example, CNC wire cutting or milling.

The at least one part of the aerofoil assembly to be received by the at least one slot, e.g. the root portion, has a width. In another embodiment the width of the exit aperture is basically the width of the at least one part of the aerofoil assembly and specifically of a root portion of the aerofoil assembly. Hence, the assembled twisted position of the at least two aerofoil assemblies will be adjusted/initiated when the part reaches the exit aperture.

An easy to handle assembling aid can be provided when it comprises a circular support with an outer surface and wherein the at least one slot is arranged in/at the outer surface. Moreover, a plurality of aerofoil assemblies or all aerofoil assembly of a turbine assembly, like a turbine cascade, can be inserted effortlessly.

A comfortable insertion of the aerofoil assemblies into the assembling aid as well as into the production disc can be provided when the at least one slot extends basically perpendicular to a circumferential direction of the circular support. In the scope of an arrangement of the slot extension as “basically perpendicular” to a circumferential direction should also lie a divergence of the slot extension in respect to the circumferential direction of about 30°. Advantageously, the slot extension is arranged perpendicular to the circumferential direction.

The circular support is advantageously a ring or a circular part of a disc, wherein the slot is integrated in the outer edge of the ring/disc. This provides a comfortable insertion of the aerofoil assemblies due to the easy construction and handling of the assembling aid.

The assembly aid advantageously comprises a plurality of slots that are arranged one after the other in circumferential direction of the circular support. Thus, all aerofoil assemblies to be inserted into the production disc can be handled together or simultaneously.

Due to the positioning of the aerofoil assembly in the exit aperture, the aerofoil assemblies are brought in there twisted position. Subsequently, the thus pre-loaded aerofoil assemblies are transferred axially into the production disc. A transfer of the aerofoil assemblies to the production disc is the mounting of the aerofoil assemblies in the disc to complete the assembling of the turbine assembly. Moreover, the transfer is performed in axial direction of the aerofoil assembly.

In addition, a depth of the assembling aid needs to be considered. If the assembling aid is effectively a thin slice of the production disc or generally is too thin an effective area to cause the needed elastically bending of the blade root along its longest axis. Advantageously, a depth of the assembling aid and its slot may be at least 50% of a depth of the production disc. Advantageously, the assembling aid or its slot, respectively, has the same depth as the production disc and thus the root portion of the aerofoil assembly.

The assembling aid may be attached to a fixture for better handling. Moreover, so ensure concentricity and proper circumferential alignment of the slot of the assembling aid with a slot of the production disc at least one alignment means, concentricity and timing feature or mating feature could be provided. They may be embodied on the aid or on the disc or on both or may be separate features just added during the assembling process. This alignment means, concentricity and timing feature or mating feature may be embodied in any way feasible for a person skilled in the art, like a corresponding lock and key pair, a clamp, an alignment tool in the form of a root dummy. With such a feature an exact alignment of the pre-twisted aerofoil assemblies and then production disc can be obtained.

The at least one slot of the assembling aid is of a first slot type and specifically can be referred to as an angled slot. According to a further embodiment the assembling aid comprises at least one slot of a second slot type. Thus, different functions of the assembling aid can be facilitated by different slots. The at least one slot of the second slot type has a constant slot width—from its entry aperture to its exit aperture. Thus, it can be referred to as a constant slot. Side surfaces of the constant slot that extend along the depth of the constant slot are arranged in parallel to one another.

When a width of the at least one slot of the second slot type is basically the width of the at least one part (root portion) of the aerofoil assembly the latter can be hold in this slot easily. The assembled twisted position of the aerofoil assemblies can be maintained easily when the width of the at least one slot of the second slot type is basically the width of the slot in the production disc. Hence, the depth of each slot (angled and constant) is the same as the depth of the root portion of the aerofoil assembly or of the slot of the production disc.

A transfer of the aerofoil assemblies in their assembled twisted position can be done comfortably when the at least one slot of the first slot type—the angled slot—and the at least one slot of the second slot type—the constant slot—are arranged one after the other in a direction basically perpendicular to a circumferential direction of the assembling aid. This would be the axial direction or the insertion direction. In other word the (each) angled slot and the (each) constant slot are arranged flush with each other.

Each slot type may be arranged in a different assembling aid or disc, wherein the two parts would be connected to one another for centricity and proper alignment via an alignment means. Alternatively, the two slot types would be embodied in the same piece reducing the risk of default alignment and saving costs and pieces as well making the handling easy.

Due to the differences between the angled slot and the constant slot also the orientation of their side surfaces differ. However, the orientation of the centre line may be the same. Thus, the centre line of the angled slot is aligned (centred) to the centre line of constant slot (with the parallel side surfaces. Moreover, the centre line of the constant slot is oriented like the centre line of the slot of the production disc or even the root portion. However, the alignment angle between the centre line of the angled/tapered slot and the constant/parallel slot should match the interlock pre-twist angle of the aerofoil assemblies.

However, as an alternative it may be possible that the centre line of the angled slot may be biased to one side, i.e. 0° to 6°, or 6° to 0° relative to the side surface(s) of the constant slot. This may advantageously suit the direction of the interlock pre-twist of the aerofoil assemblies.

Beneficially, the at least one slot of a second slot type (constant slot) has basically the same characteristics, like orientation of the centre line or the side surfaces, dimensions (width, depth, radial length), shape (contour, Christmas tree shape) as at least one slot of a production disc of the turbine assembly that is embodied in such a way to receive at least one part of an aerofoil assembly in the fully assembled state of the turbine assembly. In this the term basically should be understood in that slide deviations like ±5% between the characteristics of both slots can be neglected. Thus, the slots of the second type of slots and the slot of the production disc are matched for their proper operation. Hence, the aerofoil assemblies are hold in the constant slot in a similar arrangement or method as used in service ensuring that the torsional force is applied to the aerofoil assemblies in a safe manner. Furthermore, the constant slot may be curved in section to reduce the contact stresses when the twisting moment/torque is applied. However, the curved section would reduce the contact stresses on one side only. Unless the actual blade root is also curved the leading root edge contact stress will still remain high do to the twisting action during the fitting.

The invention further refers to a method for assembling a turbine assembly, comprising at least two aerofoil assemblies connected to each other by at least two interlocking platforms, wherein the aerofoil assemblies are brought from a free-state untwisted position to an assembled twisted position during assembling.

It is proposed that a twisting moment to achieve the assembled twisted position is applied to the at least two aerofoil assemblies by gradually engaging at least one tapered surface of an assembling aid resulting in the assembled twisted position of the at least two aerofoil assemblies.

Due to the inventive method aerofoil assemblies that requiring a high torsional pre-load can be fitted easily in the turbine assembly or its production disc, respectively. Further, the aerofoil assemblies can be effectively positioned from their free-state untwisted position to the assembled twisted position. Moreover, assembling time is minimised. Furthermore, an equal twisting moment is applied to both aerofoil assemblies providing a homogeneous arrangement or twisting angle of the aerofoil assemblies.

In this context the phrase “by gradually engaging at least one tapered surface of an assembling aid resulting in the assembled twisted position of the at least two aerofoil assemblies” should be understood as a gradual positioning of the aerofoil assembly by the tapered surface of the assembling aid to achieve the assembled twisted position, advantageously by positioning the aerofoil assembly in the exit aperture of the angled slot. Thus, the assembling aid or the angled slot thereof acts as a guide and allows the aerofoil assemblies to be inserted into the assembling aid with no pre-load issues and then inducing the preload by axial transfer across the assembling aid or the angled slot (along the depth of the slot).

The insertion of the aerofoil assembly may be done in any way feasible for a person skilled in the art, e.g. by contacting one of the surfaces or by being arranged in a centre of the slot. For example, according to the former case one side surface (e.g. the right one) of the root portion may by aligning with contact to one side surface of the slot and the other edge (e.g. the left one) of the root portion will contact the respective side surface during the insertion process. According to the latter case a front section of the root portion that enters the slot first may be placing centred in the entry aperture and the right and left edge of this front section of the root portion will connect both respective side surfaces at basically the same moment during the insertion process.

For example in case to insert a full set of aerofoil assemblies the insertion would be done with the production disc and the aerofoil assemblies arranged in their horizontal orientation. The initial aerofoil assembly would be positioned into a slot a few mm (enough to ensure it will not fall over) using a simple spacer or fixture to ensure it does not engage further. The next aerofoil assembly is fitted adjacent and then the next in one direction only until the last aerofoil assembly remains. The last aerofoil assembly is fitted but will need a bit of manipulation in respect to adjacent aerofoil assemblies to make the largest gap possible within the constraint of the tapered slots. Then the whole set is fed into the tighter section (exit aperture or the constant slot) of the assembling aid.

In a further embodiment of the invention it is proposed that the twisting moment results in an assembled twisted position of the aerofoil assembly in respect to its free state untwisted position with a twist angle of about 0.5° to 10°, advantageously about 1° to 3°, and most advantageously of about 1°. Hence, the tight connection between the aerofoil assemblies or their interlocking platforms, respectively, can be established in a narrow adjustment range. The values depend on the shape of the aerofoil e.g. the aspect ratio i.e. the length compared to the chord of the aerofoil and its variation. A longer slender aerofoil with a smaller cross section would use a larger angle compared to a shorter aerofoil with a larger cross section.

Advantageously, the twisting moment is applied to at least a root portion of the aerofoil assembly. Hence, the twisting force is applied to a robust part of the turbine assembly reducing the risk of damage to the aerofoil assembly.

According to a further realisation of the invention the root portion of the aerofoil assembly is positioned in a slot of a first slot type of the assembling aid beforehand of the application of the twisting moment, wherein a width of the slot of a first slot type at its entry aperture is wider than a width of the root portion of the aerofoil assembly. Thus, the insertion of the root portion can be done free of pre-load issues. Moreover, a homogenous and smooth adjustment of the position of the aerofoil assemblies can be provided.

Beneficially, the twisting moment is applied to the aerofoil assemblies beforehand of a positioning of the aerofoil assemblies in the production disc of the turbine assembly and specifically by positioning of the root portion in the constant slot. Thus, possible damage to the production disc can be avoided. A torsion force resulting from the twisting moment is maintained during the transfer from the assembling aid to the production disc and thus the aerofoil assemblies remain in their twisted position in the production disc.

In a further realisation of the invention it is provided that the aerofoil assemblies are transferred to a production disc of the turbine assembly in their twisted position simultaneously. This gives an effective method of insertion of the aerofoil assemblies into the production disc, minimising assembly steps, time, costs and risk of damage.

In summary the invention depicts a method of a aerofoil assembly insertion using a fixture whereby the aerofoil assemblies are all supported by the fixture and torsion is mechanically applied to root portions of the aerofoil assemblies prior to the aerofoil assemblies being inserted into the production disc. The fixture is made up from a circular disc which engages with the root portions. In this condition the outer interlocking platform or the shroud interlock faces of all of the aerofoil assemblies are engaged. The root portions are engaging the tapered surface of the assembling aid and the resulting twisting force applied by the aid is reacted at the interlock faces. Due to the engagement of the root with the surface of the aid the angle of the root portions are twisted relative to their free state. When the required root angle is achieved and the root portions are aligned with the production disc slots, the fixture and the aerofoil assemblies are moved axially to engage the slots and insert the aerofoil assemblies.

The present invention further relates to a turbine assembly preassembled and/or assembled by the inventive method.

The above-described characteristics, features and advantages of this invention and the manner in which they are achieved are clear and clearly understood in connection with the following description of exemplary embodiments which are explained in connection with the drawings.

### BRIEF DESCRIPTION OF THE DRAWING

The present invention will be described with reference to drawings in which:

FIG. 1: shows a schematically and sectional view of a gas turbine engine comprising several turbine assemblies assembled with the inventive assembling aid and according to the inventive method,

FIG. 2: shows a perspective view of tree aerofoil assemblies of a turbine assembly from FIG. 1,

FIG. 3: shows a top view of two aerofoil assemblies from FIG. 2,

FIG. 4: shows in a perspective view a production disc with the three aerofoil assemblies from FIG. 2 inserted,

FIG. 5 shows in a perspective view the production disc with the three aerofoil assemblies from FIG. 4 with an aligned assembly aid,

FIG. 6: shows in a perspective view an angled slot and a constant slot of the assembly aid from FIG. 5,

FIG. 7: shows in a top view the angled slot and the from FIG. 6,

FIG. 8: shows in a perspective view the production disc and the aligned assembly aid from FIG. 5 with an alignment tool,

FIG. 9: shows in a perspective view the alignment tool from FIG. 8 positioned in the angled slot from FIG. 5 and in a slot from the production disc,

FIG. 10: shows in a perspective view the insertion of the three aerofoil assemblies from FIG. 4 into the assembling aid from FIG. 5,

FIG. 11: shows in a perspective view the transfer of the three aerofoil assemblies from the FIG. 4 assembling aid into the aligned production disc,

FIG. 12: shows in a perspective view the three aerofoil assemblies from the FIG. 4 fully assembled in the production disc,

FIG. 13: shows in a perspective view the beginning of a de-assembly of the three aerofoil assemblies from the production disc,

FIG. 14: shows schematically an alternative side surface of a slot of the assembling aid following a curve and

FIG. 15: shows schematically in an enlarged view several facets forming the curve from FIG. 14.

### DETAILED DESCRIPTION OF THE ILLUSTRATED EMBODIMENTS

The present invention is described with reference to the above exemplary turbine engine having a single shaft or spool connecting a single, multi-stage compressor and a single, one or more stage turbine. However, it should be appreciated that the present invention is equally applicable to two or three shaft engines and which can be used for industrial, aero or marine applications. In the present description, reference will only be made to a vane, for the sake of simplicity, but it is to be understood that the invention is applicable to both blades and vanes of a turbine engine. The terms upstream and downstream refer to the flow direction of the airflow and/or working gas flow through the engine 54 unless otherwise stated. The terms forward and rearward refer to the general flow of gas through the engine 54. If used in context to the engine 54, the terms axial, radial and circumferential are made with reference to a rotational axis 64 of the engine 54.

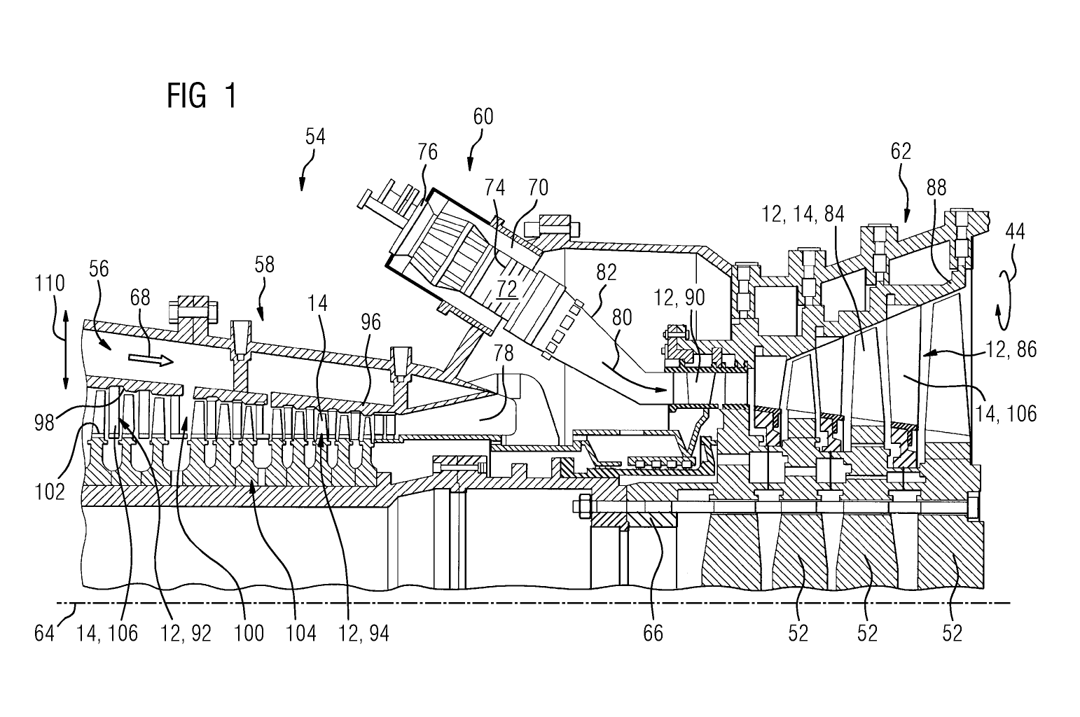

FIG. 1 shows an example of a gas turbine engine 54 in a sectional view. The gas turbine engine 54 comprises, in flow series, an inlet 56, a compressor section 58, a combustion section 60 and a turbine section 62, which are generally arranged in flow series and generally in the direction of a longitudinal or rotational axis 64. The gas turbine engine 54 further comprises a shaft 66 which is rotatable about the rotational axis 64 and which extends longitudinally through the gas turbine engine 54. The shaft 66 drivingly connects the turbine section 62 to the compressor section 58.

In operation of the gas turbine engine 54, air 68, which is taken in through the air inlet 56 is compressed by the compressor section 58 and delivered to the combustion section or burner section 60. The burner section 60 comprises a burner plenum 70, one or more combustion chambers 72 defined by a can 74 and at least one burner 76 fixed to each combustion chamber 72. The combustion chambers 72 and the burners 76 are located inside the burner plenum 70. The compressed air passing through the compressor section 58 enters a diffuser 78 and is discharged from the diffuser 78 into the burner plenum 70 from where a portion of the air enters the burner 76 and is mixed with a gaseous or liquid fuel. The air/fuel mixture is then burned and the combustion gas 80 or working gas from the combustion is channelled to the turbine section 62 via a transition duct 82.

This exemplary gas turbine engine 54 has a cannular combustor section arrangement 60, which is constituted by an annular array of combustor cans 74 each having the burner 76 and the combustion chamber 72, the transition duct 82 has a generally circular inlet that interfaces with the combustor chamber 72 and an outlet in the form of an annular segment. An annular array of transition duct outlets form an annulus for channelling the combustion gases 80 to the turbine section 62.

The turbine section 62 comprises a number of blade carrying discs 52 or turbine wheels 84 attached to the shaft 66. In the present example, the turbine section 62 comprises four discs 52 each carry an annular array of turbine assemblies 12, which each comprises an aerofoil assembly 14, 16 embodied as a turbine blade. However, the number of blade carrying discs 52 could be different, i.e. only one disc 52 or more than four discs 52. In addition, turbine cascades 86 are disposed between the turbine blades. Each turbine cascade 86 carries an annular array of turbine assemblies 12, which each comprises an aerofoil assembly 14, 16 in the form of guiding vanes, which are fixed to a stator 88 of the gas turbine engine 54. Between the exit of the combustion chamber 72 and the leading turbine blades inlet guiding vanes or nozzle guide vanes 90 are provided and turn the flow of working gas 80 onto the turbine blades.

The combustion gas 80 from the combustion chamber 72 enters the turbine section 62 and drives the turbine blades which in turn rotate the shaft 66. The guiding vanes 90 serve to optimise the angle of the combustion or working gas 80 on to the turbine blades. The turbine section 62 drives the compressor section 58.

The compressor section 58 comprises an axial series of guide vane stages 92 and rotor blade stages 94 with turbine assemblies 12 comprising aerofoils assemblies 14, 16 or turbine blades or vanes, respectively. The rotor blade stages 94 comprise a rotor disc supporting an annular array of blades. The compressor section 58 also comprises a stationary casing 96 that surrounds the rotor stages 94 and supports the vane stages 92. The guide vane stages 92 include an annular array of radially extending vanes that are mounted to the casing 96. The vanes are provided to present gas flow at an optimal angle for the blades at a given engine operational point. Some of the guide vane stages 92 have variable vanes, where the angle of the vanes, about their own longitudinal axis, can be adjusted for angle according to air flow characteristics that can occur at different engine operations conditions

The casing 96 defines a radially outer surface 98 of the passage 100 of the compressor section 58. A radially inner surface 102 of the passage 102 is at least partly defined by a rotor drum 104 of the rotor which is partly defined by the annular array of blades.

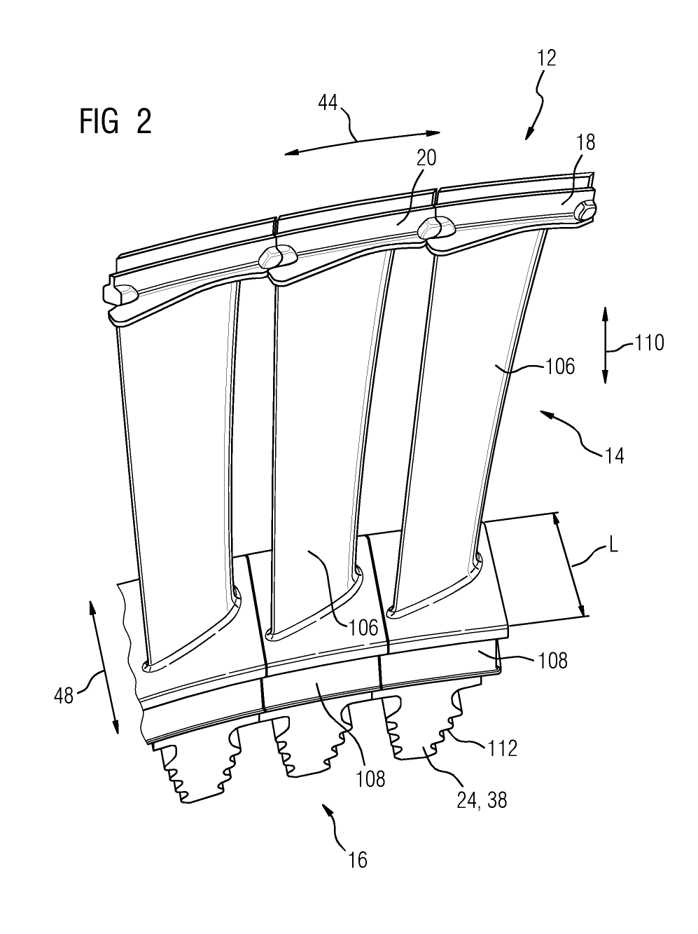

FIG. 2 shows in a perspective view a part of a turbine assembly 12 of the gas turbine engine 54 with three exemplarily shown aerofoil assemblies 14, 16 arranged in circumferential direction 44 one after the other (only two aerofoil assemblies are marked with reference numerals). Each aerofoil assembly 14, 16 comprises an aerofoil 106 with an inner platform 108 and an outer interlocking platform 18, 20 or a shroud, respectively, at its opposed ends. Moreover, in radial direction 110 at an inner end of the inner platform 108 each aerofoil assembly 14, 16 comprises a part 24 or a root portion 38, respectively, with a Christmas tree contour 112.

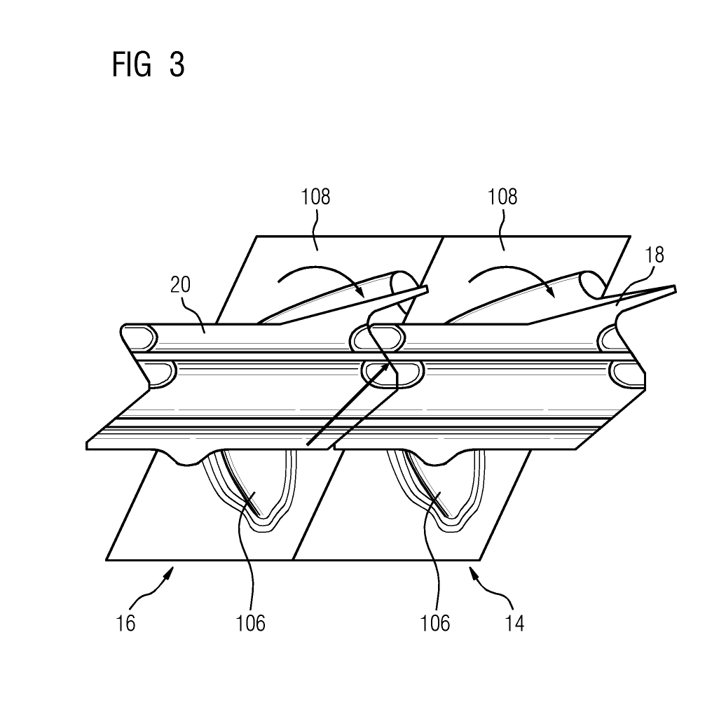

In FIG. 3 the aerofoil assemblies 14, 16 are shown in a top view in an assembled twisted position where the aerofoil assemblies 14, 16 are connected to each other by the interlocking platforms 18, 20 which engage tightly in a close form fit (see straight arrow). To achieve this position the aerofoil assemblies 14, 16 had to be twisted during their assembling as it is depicted by the half circular arrows.

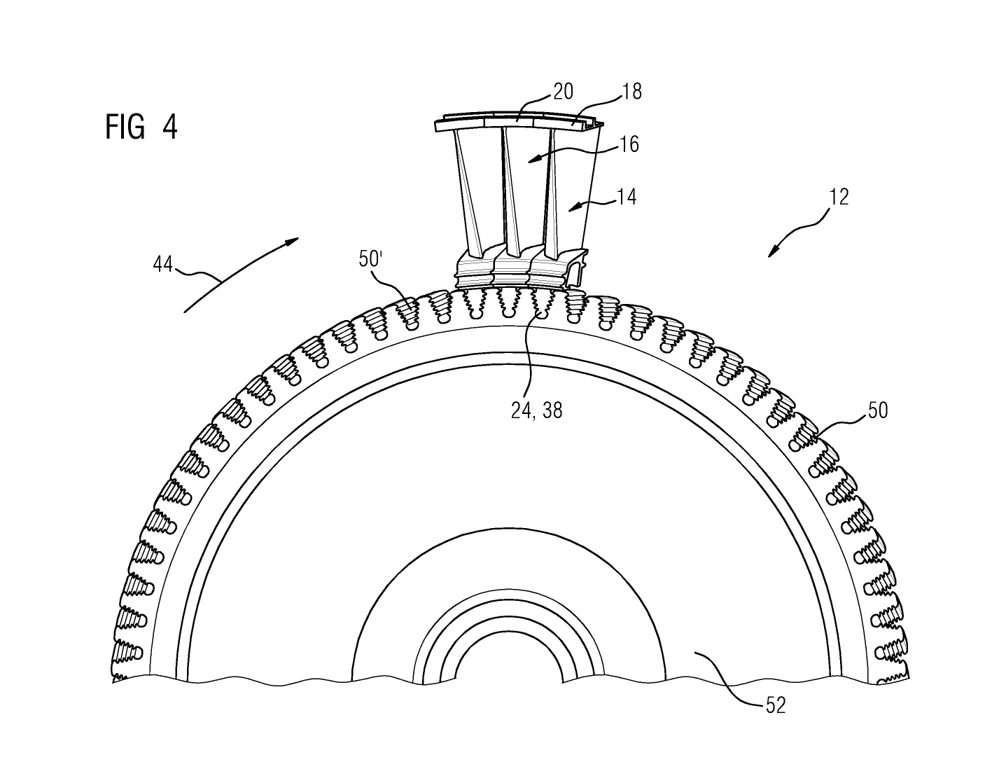

The inserted aerofoil assemblies 14, 16 into slots 50, 50′ of the production disc 52 is depicted in FIG. 4 that shows in a perspective view the production disc with the three aerofoil assemblies from FIG. 2 (Please note that for better presentability other slots than the occupied slots are marked with the reference numerals.). The production disc 52 has several in circumferential direction 44 arranged slots 50, 50′ with a Christmas tree contour 112.

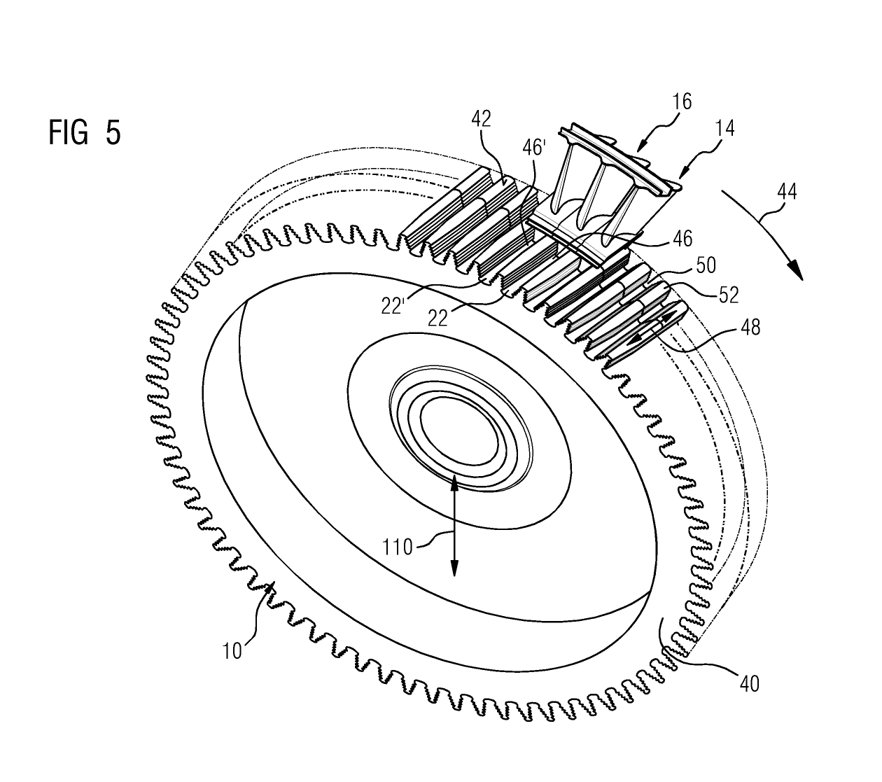

For the assembling of the turbine assembly 12 or the aerofoil assemblies 14, 16 in the production disc 52 an assembling aid 10 is used. The production disc 52 with the inserted aerofoil assemblies 14, 16 and an aligned assembling aid 10 and are shown in FIG. 5 that shows a perspective view of the parts after an assembly.

The assembling aid 10 has the form of a ring comprising a circular support 40 with an outer surface 42. The outer surface 42 comprises a first type of slots 22, 22′ and a second type of slots 46, 46′ (details see below). The slots 22, 22′, 46′ 46′ are embodied to receive the part 24 or the root portion 38, respectively, of the aerofoil assemblies 14, 16. The slots 22, 22′, 46, 46′ extend basically perpendicular to the circumferential direction 44 of the circular support 40 or in axial direction 48. The axial direction 48 is also the insertion direction of the aerofoil assemblies 14, 16 during the assembling. Moreover, a plurality of slots 22, 22′, 46, 46′ or the same number as aerofoil assemblies 14, 16 per each slot type are arranged one after the other in circumferential direction 44 of the circular support 40. The slots 22, 22′, 46, 46′ comprise a Christmas tree contour 112 embodied correspondingly to the contour of the root portion 38 of the aerofoil assemblies 14, 16.

Moreover, each slot 22, 22′ of the first slot type and each slot 46, 46′ of the second slot type are arranged one after the other in axial direction 48 (arranged basically perpendicular to the circumferential direction 44).

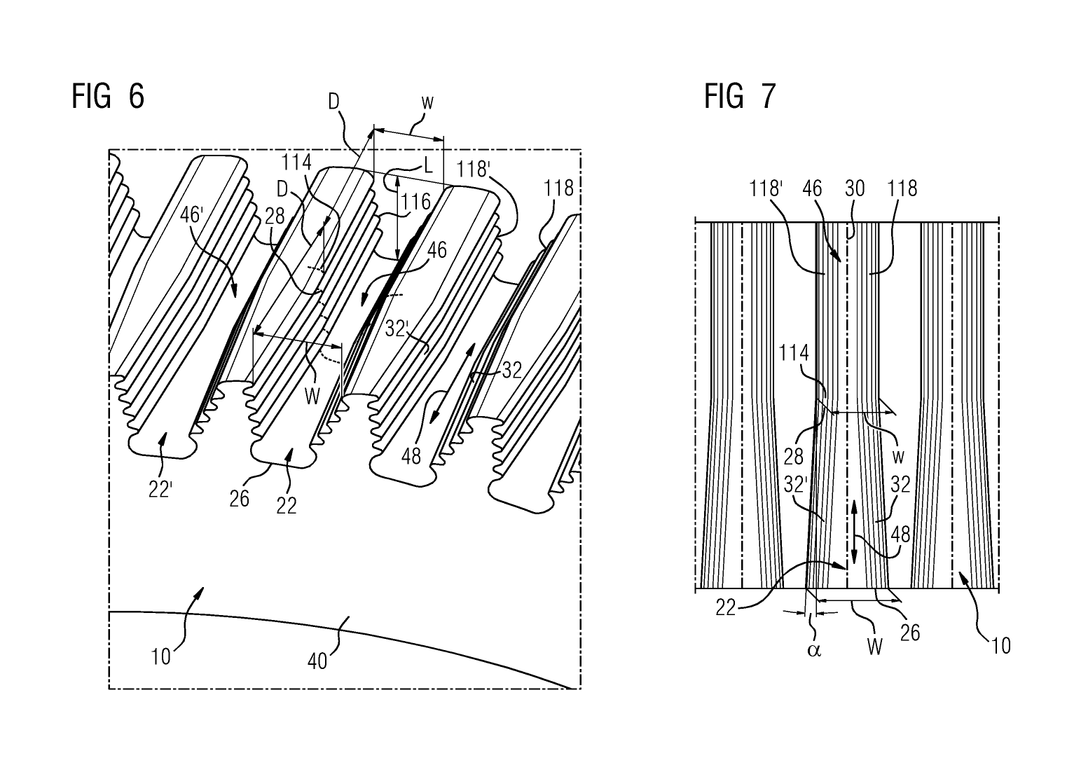

The two slot types are shown in more detail in FIGS. 6 and 7 that show a perspective view and a top view of the slots 22, 22′, 46, 46′. The following description refers exemplarily to the slots 22 and 46.

For the insertion of the aerofoil assemblies 14, 16 the slot 22 has an entry aperture 26 and for exiting the slot 22 an exit aperture 28. The slot 46 as well has an entry aperture 114 and an exit aperture 116. Furthermore, both slots 22, 46 have a depth D extending from the respective entry aperture 26, 114 to the respective exit aperture 28, 116. The depth D is the same as a depth of the root portion 38 of the aerofoil assemblies 14, 16 (not shown in detail).

For easy access of the slot 22 a width W of the entry aperture 26 is wider than a width w of the exit aperture 28. A width w of the slot 46 and its entry/exit apertures 114, 116 are the same as the width w of the exit aperture 28 of slot 22. Thus, slot 46 has a constant slot width w. Thus, side surfaces 118, 118′ of the slot 46 that extend along the depth D of the slot 46 are arranged in parallel to one another. Moreover, the slot 46 has basically the same characteristics (like contour, width w, depth D, radial length L) as the slot 50 of the production disc 52.

Both slots 22, 46 have a centre line 30 along their depth D. In this exemplary embodiment the centre lines 30 of both slots are aligned with each other, thus only one centre line 30 is shown.

The slot 22 has two side surfaces 32, 32′ extending along the depth D of the slot 22 from the entry aperture 26 to the exit aperture 28. The side surfaces 32, 32′ are oriented angled with a taper along the depth D of the slot 22 and in respect to the centre line 30. The slot 22 is an angled slot 22. Consequently, the width W, w of the at least one slot 22, 22′ reduces along the depth D in a continuous fashion. Moreover, the side surfaces 32, 32′ are also angled in respect to the side surfaces 118, 118′ of the constant slot 46.

An angle α included between the side surface 32, 32′ of the slot 22 and the centre line 30 has a value between 0° and ±15°, advantageously between 0° and ±10°, most advantageously between 0° and ±6° and in this exemplary embodiment of 3°

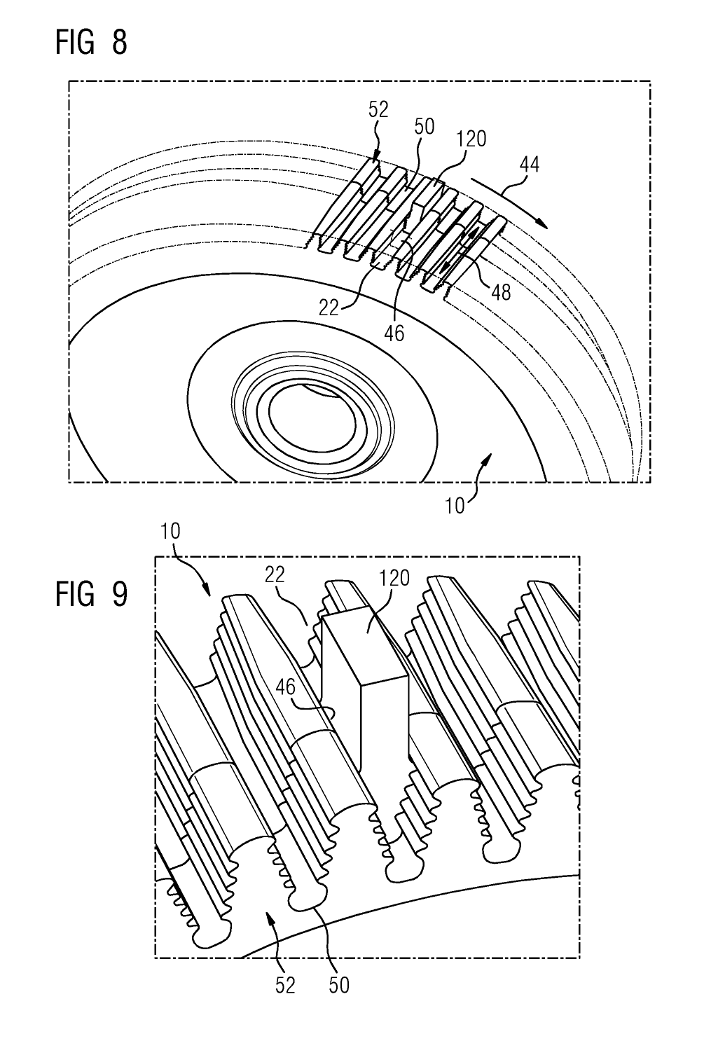

An assembling method will be described in the following text with reference to FIGS. 8 to 12.

FIG. 8 shows the production disc 52 with its slots 50 and the assembling aid 10 with is respective slots 22, 46 in an aligned position towards each other. To ensure concentricity and proper alignment an alignment tool 120 is used. It is embodied as a dummy root portion and is inserted with approximately equal parts in the slot 50 of the production disc 52 and the slot 46 of the assembling aid 10 (see FIG. 9). To further secure the relative position of the parts to one another the production disc 52 and the assembling aid 10 are clamped together (not shown in detail).

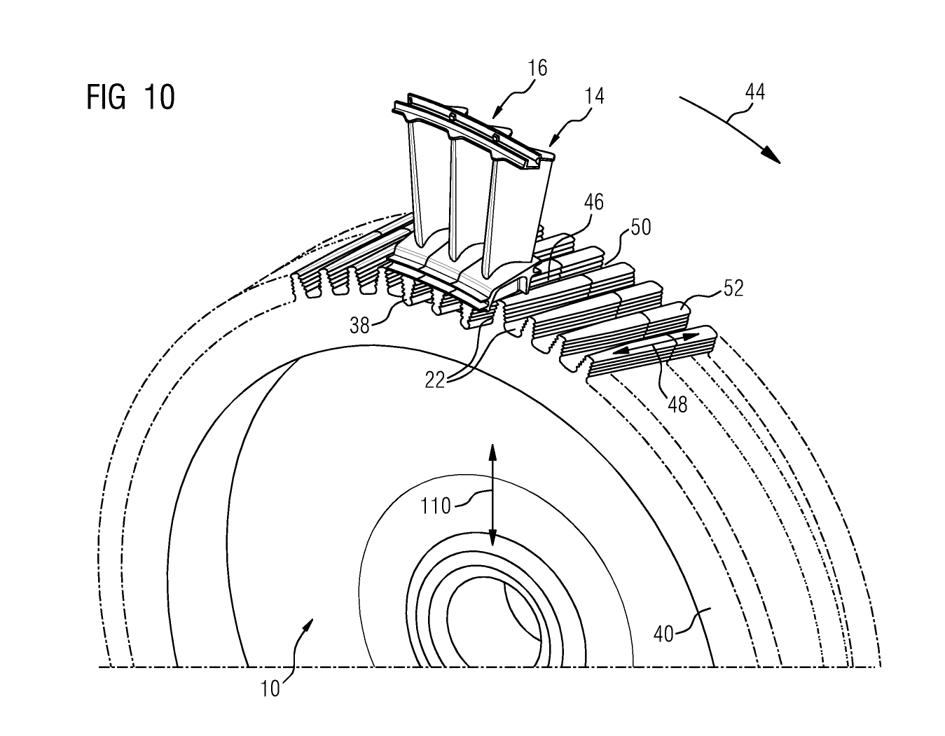

At a subsequent step the root portions 38 are inserted in axial direction 48 into the slot 22 of the assembling aid 10 and are positioned in the free state (see FIG. 10). Along the way the root portions 38 will gradually engage at least one of the angled or tapered side surfaces 32, 32′ and will be finally positioned in the exit aperture 28 of slot 22. At this point a twisting moment to achieve the assembled twisted position is applied to the aerofoil assemblies 14, 16 resulting in the assembled twisted position of the aerofoil assemblies 14, 16. Thus, due to the positioning of the root portions 22 in the exit aperture 28 and subsequently in the slots 46 the aerofoil assemblies 14, 16 are brought simultaneously from the free-state untwisted position to the assembled twisted position during assembling.

The aerofoil assemblies 14, 16 are twisted such that the root portions 38 are at the correct assembled angle relative to a turbine engine centreline. In other words, torsion is applied to orient the root portion 38 to match the slot 50 of the production disc 52. Generally, the slot 50 in the production disc 52 would always have an angle relative to the turbine engine centreline. A twist angle is an addition, a portion of that angle (not shown in detail).

The adjustment of the correct angel is done by the engagement force acting on the root portion 38. The twisting moment results in an assembled twisted position of the aerofoil assembly 14, 16 in respect to its free state untwisted position with a twist angle of about 0.5° to 10°, advantageously about 1° to 3°, and most advantageously of about 1° (not shown in detail). The force results also in an angle of twist of the root portion 38 relative to a tip of the aerofoil assembly 14, 16. Every aerofoil assembly 14, 16 typically has the same angle of twist imparted.

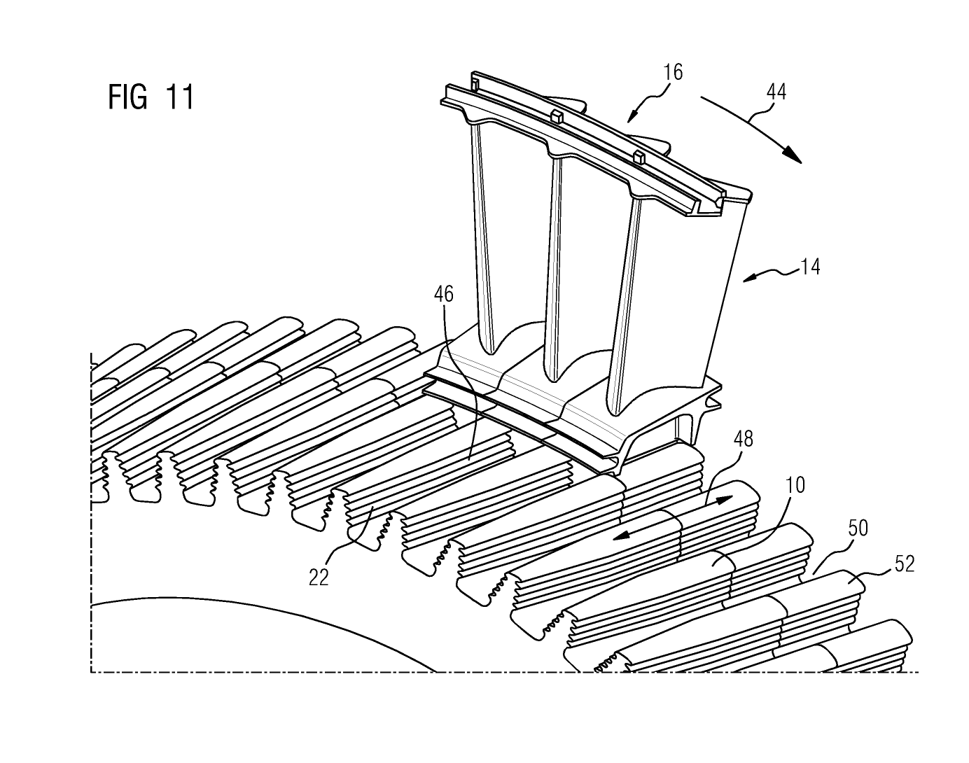

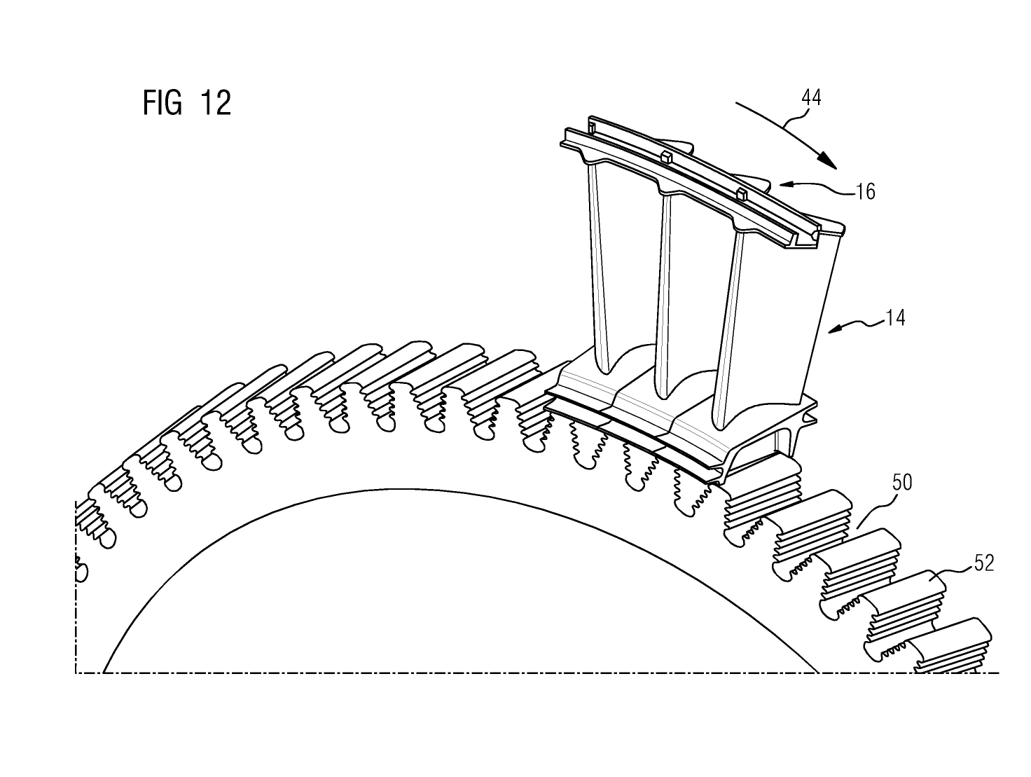

At this point the aerofoil assemblies 14, 16 are constrained in the twisted condition by engagement into the constant slot 46. In the next step the aerofoil assemblies 14, 16 are transferred to the production disc 52 by applying a simultaneous force to all turbine assemblies 14, 16 in axial direction 48 or in the direction of the root portion 38 or the slots 50 of the production disc 52 or in other words by pressing the aerofoil assemblies 14, 16 into position using a helical motion or along a path to match the slot 50 of the production disc 52. It may be also possible to transfer them by continued progressively tapping the aerofoil assemblies 14, 16 until they have passed from the constant slot 46 of the assembling aid 10 into the production disc 52 to the final position. This can be seen in FIG. 11. Thus, the twisting moment is applied to the aerofoil assemblies 14, 16 beforehand of a positioning of the aerofoil assemblies 14, 16 in the production disc 52 of the turbine assembly 12. Thereafter the assembling aid 10 can be removed. This fully assembled position is shown in FIG. 12.

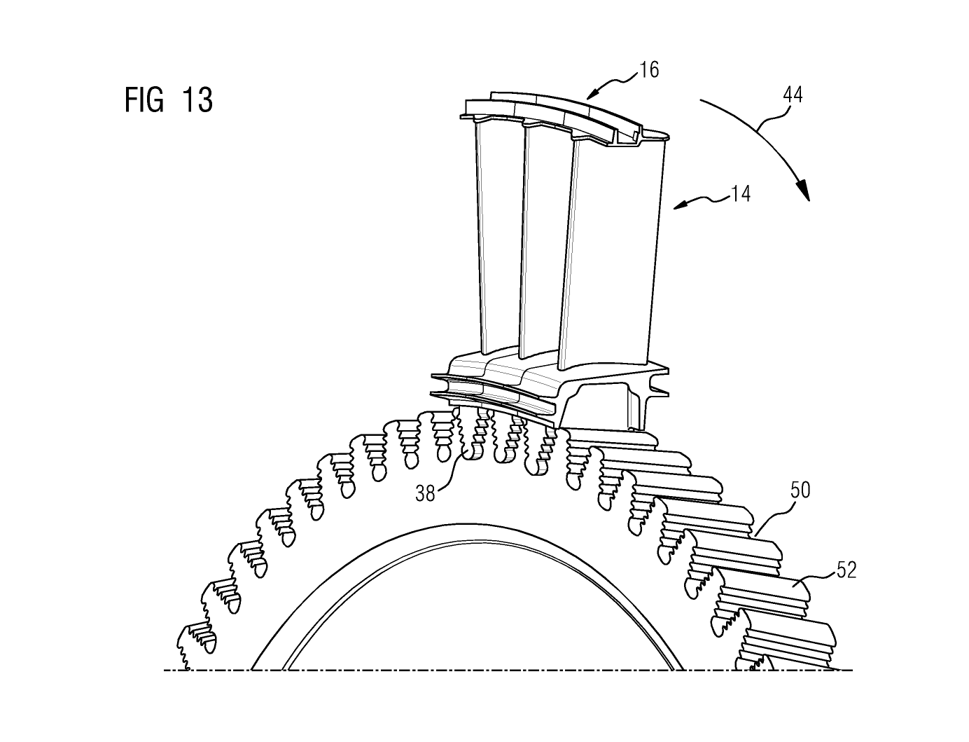

The assembling aid 10 can also be used for the de-assembling of the turbine assembly 12. This can be done in two ways. Either by fitting and clamping the assembling aid 10 using e.g. concentricity and timing features on the production disc 52 for alignment. Subsequently the aerofoil assemblies 14, 16 can be tapped progressively back into the assembling aid 10 (not shown). Or by progressively tapping the root portions 38 of the aerofoil assemblies 14, 16 out a small amount, like it is shown in FIG. 13. Thereafter the protruding root portions 38 can be fitted into the slots 46, 46′ of the assembling aid 10 to ensure correct alignment (not shown).

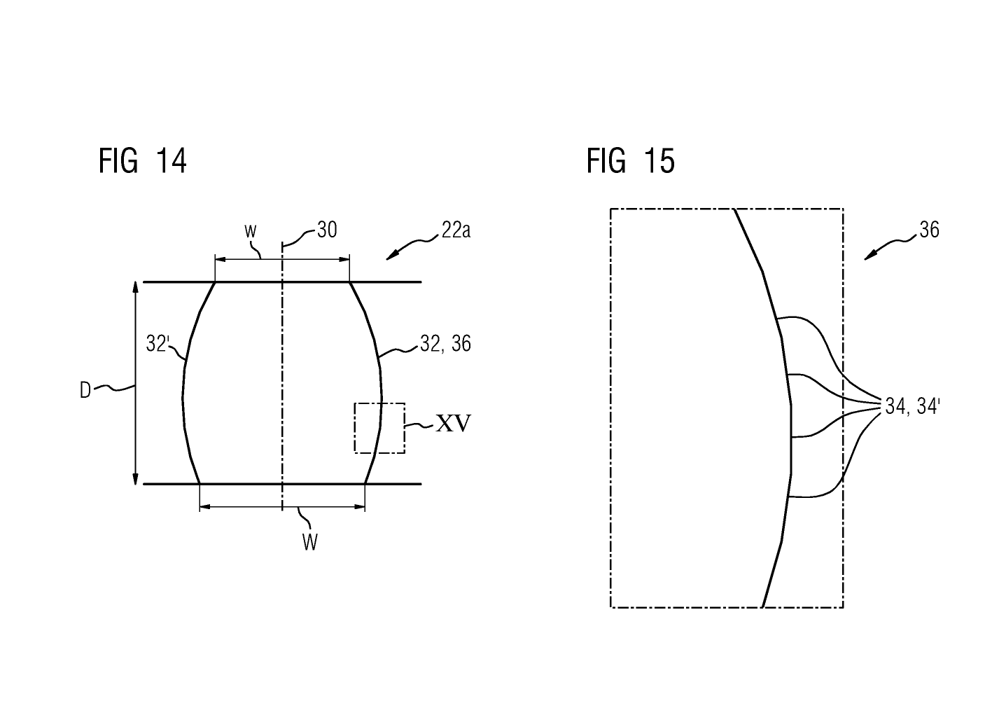

In FIGS. 14 and 15 an alternative embodiment of the slot 22 and the side surfaces 32, 32′ are shown. Components, features and functions that remain identical are in principle substantially denoted by the same reference characters. To distinguish between the embodiments, however, the letter “a” has been added to the different reference characters of the embodiment in FIGS. 14 and 15. The following description is confined substantially to the differences from the embodiment in FIGS. 1 to 13, wherein with regard to components, features and functions that remain identical reference may be made to the description of the embodiment in FIGS. 1 to 13.

In FIGS. 14 and 15 an alternative slot 22a with alternatively shaped side surfaces 32a, 32a′ is shown in a schematic depiction of the relevant features of the slot 22a. This embodiment differs in such a way from the embodiment shown in FIGS. 1 to 13 that side surfaces 32a, 32a′ comprise a plurality of facets 34, 34′ to simulate a curve 36 along a depth D of the slot 22a and in respect to a centre line 30 of the slot 22a to provide a tapered surface. FIG. 15 shows the facets 34, 34′ of the curve 36 from FIG. 14 in an enlarged view.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

Although the invention is illustrated and described in detail by the preferred embodiments, the invention is not limited by the examples disclosed, and other variations can be derived therefrom by a person skilled in the art without departing from the scope of the invention.

1. An assembling aid for assembling or de-assembling a turbine assembly having at least two aerofoil assemblies connected to each other by at least two interlocking platforms, wherein the at least two aerofoil assemblies are brought from a free-state untwisted position to an assembled twisted position during assembling, comprising:
at least one slot embodied in such a way to receive at least one part of an aerofoil assembly, wherein the at least one slot has an entry aperture and an exit aperture,
wherein a width of the entry aperture of the at least one slot is wider than a width of the exit aperture of the at least one slot.

2. The assembling aid according to claim 1,
wherein the at least one slot has a depth extending from the entry aperture to the exit aperture and
wherein a width of the at least one slot reduces along the depth in a continuous fashion.

3. The assembling aid according to claim 1,
wherein the at least one slot has a centre line along the depth of the at least one slot and has at least one side surface extending along the depth of the at least one slot and
wherein the at least one side surface is angled with a taper along the depth of the at least one slot and in respect to the centre line of the at least one slot.

4. The assembling aid according to claim 3,
wherein an angle included between the at least one side surface of the at least one slot and the centre line of the at least one slot has a value between 0° and ±15°.

5. The assembling aid according to claim 1,
wherein the at least one slot has a centre line along the depth of the at least one slot and has at least one side surface extending along the depth of the at least one slot and
wherein the at least one side surface comprises a plurality of facets to simulate a curved along the depth of the at least one slot and in respect to the centre line of the at least one slot.

6. The assembling aid according to claim 1,
wherein the at least one part of the aerofoil assembly to be received by the at least one slot has a width and
wherein the width of the exit aperture is basically the width of the at least one part of the aerofoil assembly.

7. The assembling aid according to claim 1, further comprising
a circular support with an outer surface and
wherein the at least one slot is arranged in/at the outer surface and/or wherein the at least one slot extends basically perpendicular to a circumferential direction of the circular support and/or
wherein a plurality of slots are arranged one after the other in circumferential direction of the circular support.

8. The assembling aid according to claim 1,
wherein the at least one slot is of a first slot type and
wherein the assembly aid comprises at least one slot of a second slot type having a constant slot width and/or
wherein a width of the at least one slot of the second slot type is basically the width of the at least one part of the aerofoil assembly and/or
wherein the at least one slot of the first slot type and the at least one slot of the second slot type are arranged one after the other in a direction basically perpendicular to a circumferential direction of the assembling aid.

9. The assembling aid according to claim 8,
wherein the at least one slot of a second slot type has basically the same characteristics as at least one slot of a production disc of the turbine assembly that is embodied in such a way to receive at least one part of the aerofoil assembly in the fully assembled state of the turbine assembly.

10. A method for assembling a turbine assembly, having at least two aerofoil assemblies connected to each other by at least two interlocking platforms, wherein the aerofoil assemblies are brought from a free-state untwisted position to an assembled twisted position during assembling, the method comprising:
applying a twisting moment to achieve the assembled twisted position to the at least two aerofoil assemblies by gradually engaging at least one tapered surface of an assembling aid resulting in the assembled twisted position of the at least two aerofoil assemblies.

11. The method according to claim 10,
wherein the twisting moment results in an assembled twisted position of the aerofoil assembly in respect to its free state untwisted position with a twist angle of about 0.5° to 10°.

12. The method according to claim 10,
wherein the twisting moment is applied to at least a root portion of the aerofoil assembly.

13. The method according to claim 12,
wherein the root portion of the aerofoil assembly is positioned in a slot of a first slot type of the assembling aid beforehand of the application of the twisting moment,
wherein a width of the at least one slot of a first slot type at its entry aperture is wider than a width (w) of the root portion of the aerofoil assembly.

14. The method according to claim 10,
wherein the twisting moment is applied to the aerofoil assemblies beforehand of a positioning of the aerofoil assemblies in a production disc of the turbine assembly.

15. The method according to claim 10, further comprising:
transferring the aerofoil assemblies to a production disc of the turbine assembly in their twisted position simultaneously.

16. The assembling aid according to claim 4,
wherein the centre line of the at least one slot has a value between 0° and ±10°.

17. The assembling aid according to claim 4,
wherein the centre line of the at least one slot has a value between 0° and ±6°.

18. The assembling aid according to claim 6,
wherein the width of the exit aperture is basically the width of a root portion of the aerofoil assembly.

19. The method according to claim 11,
wherein the twist angle is about 1° to 3°.

20. The method according to claim 11,
wherein the twist angle is about 1°.
